(19) United States
(12) Patent Application Publication
(10) Pub. No.: US 2023/0371513 A1
(43) Pub. Date: Nov. 23, 2023

(54) PHOTOSTABLE COMPOSITION AND METHOD OF REDUCING OR CONTROLLING WEED POPULATION APPLYING SAID COMPOSITION

(71) Applicants: UPL DO BRASIL INDUSTRIA E COMERCIO DE INSUMOS AGROPECUARIOS S.A., Ituverava (BR); UPL Corporation Limited, Port Louis (MU)

(72) Inventors: Ferdinando Marcos Lima Silva, Ituverava (BR); Ana Flávia Queiroz, Ituverava (BR)

(21) Appl. No.: 18/247,530

(22) PCT Filed: Oct. 1, 2021
(86) PCT No.: PCT/BR2021/050427

§ 371 Date: Mar. 31, 2023

(30) Foreign Application Priority Data
Oct. 1, 2020 (BR) BR 10 2020 020168

(51) Int. Cl. A01N 43/653; A01N 25/22; A01P 13/00

(52) U.S. Cl. CPC A01N 43/653; A01N 25/22; A01P 13/00

(57) ABSTRACT

The present invention discloses a photostable composition and method of reducing or controlling weed population applying said composition. The present invention provides compositions of triazolone herbicides protected from photodamage with the help of photoprotective agents.

### CROSS REFERENCE TO RELATED APPLICATIONS

This application is a National Stage application of PCT/BR2021/050427, filed Oct. 1, 2021, which claims priority to Brazilian Patent Publication No. 102020020168-9, filed Oct. 1, 2020, and Brazilian Patent Publication No. 102021019763-3, filed Oct. 1, 2020, both of which are incorporated by reference in their entirety herein.

### FIELD OF INVENTION

The present invention relates to stable compositions of triazolone herbicides. More specifically, the invention relates to compositions of triazolone herbicides protected from photodamage with the help of photoprotective agents. The invention, additionally, relates to applications and methods of making the same.

### BACKGROUND OF INVENTION

Many pesticides are susceptible to degradation by light, also known as photodegradation, due to their chemistry which involves active groups. Most herbicides are photoactive, because their structure generally includes aromatic rings, heteroatoms, and other functional groups that make them susceptible to absorption of UV-vis radiation (direct photolysis) or to reaction with photosensitive species capable of inducing the photodegradation of herbicides. It has been found that UV light is the most damaging.

The decomposition due to sensitivity to sunlight might already take place already during storage or even more after application to the environment. As a result, the pesticidal activity decreases, higher amounts of pesticides have to be applied, the pesticides have to be applied and reapplied in shorter intervals, or eventually toxic degradation products are produced.

Triazolones are a group of photolabile herbicide and get degraded easily. Amicarbazone degrades slowly in soil and water surfaces when exposed to sunlight, suggesting direct photolysis in air is possible. Also, in laboratory conditions with artificial light, amicarbazone shows a half life of less than 10 hours. Direct photolysis of sulfentrazone in aqueous solutions is rapid (half-life of 1 to 12 hours) as per “Willut J M et al; In Picogram, Preprint Abstract, Iss. 52, Amer Chem Soc, Div Agrochem (1997)” Most methods utilized for photoprotection include microencapsulation, or binding the formulation in water-soluble polymers. In these methods the formulation mixture is dissolved in an oil phase, the resulting mixture is emulsified in water, and the emulsion is subsequently encapsulated. The disadvantage of this process is, however, the complicated microencapsulation process. Moreover, the formulations are not always sufficiently stabilized against environmental factors, despite the encapsulation, because the thin capsule wall does not provide sufficient protection against photochemical degradation.

Accordingly, there is a continuing need for pesticide formulations that are sufficiently stabilized against environmental factors.

### SUMMARY OF THE INVENTION

One object of the invention was to provide an agrochemical formulation comprising a triazolone pesticide, which reduces the decomposition of the pesticide due to sunlight, especially due to ultraviolet (UV) light.

Another object of the invention was to provide a method of protecting a triazolone herbicide from photodamage.

Another object was to increase the stability of agrochemical formulation of pesticides during storage and/or after application to the environment.

Yet another object was to increase, optimize and enhance the pesticidal activity of agrochemical formulations after application to the environment.

Keeping in accordance with the above objects of the invention, an aspect of the present invention is to provide a composition comprising a triazolone herbicide and at least one photoprotective agent.

An aspect of the present invention is to provide a stable composition comprising a triazolone herbicide and a photoprotective agent. The said herbicide may be a photosensitive herbicide such as amicarbazone. bencarbazone, carfentrazone, carfentrazone-ethyl, flucarbazone, ipfencarbazone, propoxycarbazone, sulfentrazone and thiencarbazone or a combination thereof.

Another aspect of the present invention is to provide a method of protecting a triazolone herbicide from photodamage, wherein the method comprises adding a photoprotective agent to the composition comprising the said herbicide. The method in turn also increases the efficacy and shelf-life of the resultant herbicidal composition.

Yet another aspect of the present invention is to provide a method of preparing a composition comprising a triazolone herbicide and a photoprotective agent.

An aspect of the present invention is to provide a formulation comprising a triazolone herbicide, at least one photoprotective agent and at least one agrochemically suitable excipient.

Another aspect of the invention is to provide a kit of parts comprising a component of triazolone herbicide and another component comprising a photoprotective agent.

An aspect of the invention is also to provide an effective herbicidal composition safe from photodamage, wherein the said composition comprises a triazolone herbicide, a photoprotective agent and optionally an additional agrochemical.

Also, an aspect of the present invention is to provide for application and use of the above-mentioned composition in reducing weed population, specially in crops like sugarcane, soybean, cotton, corn, coffee and eucalyptus.

### DETAILED DESCRIPTION OF THE INVENTION

Reduced efficacy and availability of the herbicide to act on the target due to light-induced damage of the active ingredient is a cause of concern for which solutions are being explored. The inventors of the present invention surprisingly found that addition of photoprotective agent such as, but not limited to, metal oxide or a vegetable oil or a combination thereof, to a herbicidal composition comprising a photolabile herbicide significantly reduces the photodamage and degradation of the active ingredient, thereby stabilizing the composition leading to more shelf life and increased efficacy.

As described herein, the term “photoprotective agent” or “photoprotector” or “photoprotectant” includes any agent which prevents damage induced by any form of light radiation. It includes protection from IR light, visible light, sunlight, UV light and any other forms of such wavelengths. It refers to refers to any compound that can prolong the half-life of photolabile pesticide or increase the stability of photolabile pesticide when exposed to light. A photoprotectant typically absorbs, blocks, and/or reflects at least a portion of the harmful light to reduce the amount of exposure to the photolabile pesticide. The agents may be UV absorbers, UV scattering agents, UV blockers, physical agents, inorganic UV filters and organic UV filters.

The expression “UV absorber” or “UV filter” relates to all chemical compounds which can absorb UV light. The UV absorber can scatter UV light (like inorganic UV absorbers) or absorb it. It can also be referred to as a “UV scatterer”. The extinction coefficient of the UV absorber of UV light is usually greater than the extinction coefficient of the pesticide at the same wavelength. The UV absorbers can be oil-soluble or water-soluble. They can also be bonded into polymers, for example as copolymerized. The UV absorbers can be UV-A absorbers, UV-B absorbers, broad band absorbers (i.e. UV-A and UV-B) or optical brighteners. The UV absorbers can be employed in the pure form, as a technical grade mixture or as a mixture of various UV absorbers.

Organic UV photoprotective filters are understood as meaning organic substances which are able to absorb ultraviolet rays and give off the absorbed energy again in the form of longer-wave radiation, e.g., heat. The term “Organic UV photoprotective filter” relates to one type or a mixture of different types of said compounds. The organic substances may be oil-soluble or water-soluble or they may be bound to a polymer. The photoprotective filters may be UV-A and UV-B filters, preferably UV-B filters. Typically, the photoprotective filters are colorless to light yellow compounds. Preferably, the photoprotective filters can not be detected visually at the applied concentration. The UV-A and UV-B filters can also be used together in mixtures.

UV-B filters which may be used are, for example, the following substances: 3-benzylidenecamphor and derivatives thereof, e.g. 3-(4-methylbenzylidene)camphor; -4-aminobenzoic acid derivatives, preferably 2-ethylhexyl 4-(dimethylamino)benzoate, 2-octyl 4-(dimethylamino)benzoate and amyl 4-(dimethylamino)benzoate; esters of cinnamic acid, preferably 2-ethylhexyl 4-methoxycinnamate, propyl 4-methoxycinnamate, isoamyl 4-methoxycinnamate, isopentyl 4-methoxycinnamate, 2-ethylhexyl 2-cyano-3-phenylcinnamate (otocrylene); esters of salicylic acid, preferably 2-ethylhexyl salicylate, 4-isopropylbenzyl salicylate, homomenthyl salicylate; derivatives of benzophenone, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 2-ethylhexyl 4-methoxybenzmalonate; -triazine derivatives, such as 2,4,6-trianilino(p-carbo-2′-ethyl-1′-hexyloxy)-1,3,5-triazine (octyltriazone) and dioctylbutamidotriazone (Uvasorb® HEB). Propane-1,3-diones, such as, for example, 1-(4-tert-butylphenyl)-3-(4′-methoxyphenyl)propane-1,3-dione. 2-phenylbenzimidazole-5-sulfonic acid and alkali metal, alkaline earth metal, ammonium, alkylammonium, alkanolammonium and glucammonium salts thereof; sulfonic acid derivatives of benzophenones, preferably 2-hydroxy-4-methoxybenzo-phenone-5-sulfonic acid and its salts; sulfonic acid derivatives of 3-benzylidenecamphor, such as, for example, 4-(2-oxo-3-bornylidenemethyl)benzenesulfonic acid and 2-methyl-5-(2-oxo-3-bornylidene)sulfonic acid and salts thereof.

Suitable UV-A filters are:—derivatives of benzoylmethane, such as, for example, 1-(4′-tert-butylphenyl)-3-(4′-methoxyphenyl)propane-1,3-dione, 4-tert-butyl-4′-methoxydibenzoylmethane or 1-phenyl-3-(4′-isopropylphenyl)propane-1,3-dione; -Aminohydroxy-substituited derivatives of benzophenones, such as, for example, N,N-diethylaminohydroxybenzoyl-n- hexylbenzoate.

In a preferred embodiment, the UV absorber is water-soluble. In a further preferred embodiment, the composition comprises a further UV absorber, the further UV absorber being oil-soluble. In particular, at least one UV absorber is water-soluble and at least one UV absorber is oil-soluble.

UV light is defined as electromagnetic radiation having wavelengths from about 200 nm 400 nm, typically from 290 nm to 400 nm. Within this range of wavelengths, UV light can be subdivided into UV-A (wavelength from about 320 to about 400 nm) and UV-B (wavelength from about 290 to about 320 nm).

Keeping in accordance with the above objects of the invention, an aspect of the present invention is to provide a composition comprising at least one triazolone herbicide and at least one photoprotective agent.

According to an embodiment, the said triazolone herbicide is selected from amicarbazone, bencarbazone, carfentrazone, carfentrazone-ethyl, flucarbazone, ipfencarbazone, propoxycarbazone, sulfentrazone and thiencarbazone.

According to an embodiment, the said triazolone herbicide is amicarbazone.

According to an embodiment, the said triazolone herbicide is sulfentrazone.

According to an embodiment, the said triazolone herbicide is flucarbazone.

According to an embodiment, the said triazolone herbicide is carfentrazone or carfentrazone-ethyl.

According to an embodiment, the said triazolone herbicide is ipfencarbazone.

According to an embodiment, the said triazolone herbicide is propoxycarbazone.

According to an embodiment, the said triazolone herbicide is thiencarbazone.

As per another embodiment, the said photoprotective agent is selected from
A) benzotriazoles, such as 2-(2H-benzotriazol-2-yl)-4,6-bis(1-methyl-1-phenylethyl)phenol, [3-[3-(2H-benzotriazol-2-yl)-5-(1,1-dimethylethyl)-4-hydroxyphenyl]-1-oxopropyl]-w-[3-[3-(2H-benzotriazol-2-yl)-5-(1,1-dimethylethyl)-4-hydroxyphenyl]-1-oxopropoxy]poly(oxy-1,2-ethanediyl), 6-tert-butyl-2-(5-chloro-2H-benzotriazol-2-yl)-4-methylphenol, 2,4-di-tert-butyl-6-(5-chloro-2H-benzotriazol-2-yl)-phenol, 2-(2H-benzotriazol-2-yl)-4,6-di-tert-pentylphenol, 2-(2H-benzotriazol-2-yl)-4-(1,1,3,3-tetramethylbutyl)-phenol, 2-(2H-benzotriazol-2-yl)-4-methylphenol, 2-(2H-benzotriazol-2-yl)-4,6-bis(1-methyl-1-phenylethyl)phenol, 2,2-methylenebis(6-(benzotriazol-2-yl)-4-tert-octylphenol; 2-(2H-benzotriazol-2-yl)-2-(2-methylpropyl)phenol-4-sulfonic acid sodium salt, phenol, 2-(2H-benzotriazol-2-yl)-6-dodecyl-4-methyl-, branched and linear;
B) cyanoacrylates, such as 2-cyano-3-phenylcinnamate ethyl ester, 2-cyano-3,3-diphenylacrylic acid 2′-ethylhexyl ester or 2-ethylhexyl 2-cyano-3-phenylcinnamate;
C) para-aminobenzoic acid (PABA) derivatives, in particular esters, such as ethyl PABA, ethoxylated PABA, ethyl dihydroxypropyl-PABA, glycerol-PABA, 2-ethylhexyl 4-(dimethylamino)benzoate, 2-octyl 4-(dimethylamino)benzoate, amyl 4-(dimethylamino)benzoate, 4-bis(polyethoxy)-4-aminobenzoic acid polyethoxyethyl ester;
D) esters of salicylic acid, such as 2-ethylhexyl salicylate, 4-isopropylbenzyl salicylate, homomethyl salicylate (homosalate), TEA salicylate, dipropylene glycol salicylate, Ethylhexyl salicylate (octyl salicylate/octisalate), Trolamine salicylate;
E) esters of cinnamic acids, such as 2-ethylhexyl 4-methoxycinnamate, octyl p-methoxycinnamate (octinoxate), propyl 4-methoxycinnamate, isoamyl 4-methoxycinnamate, cinoxate, diisopropyl methylcinnamate, ethoxyethyl p-methoxycinnamate (cinoxate), etocrylene, octocrylene;
F) derivatives of benzophenone, such as 2-hydroxy-4-methoxybenzophenone, 2-hydroxy-4-methoxy-4′-methylbenzophenone, 2,2′-dihydroxy-4-methoxybenzophenone, 2-(4-diethylamino-2-hydroxybenzoyl)-benzoic acid hexyl ester, 4-n-octyloxy-2-hydroxy-benzophenone 2-hydroxybenzophenone derivatives, such as 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone, sulfonic acid derivatives of benzophenones, such as 2-hydroxy-4-methoxybenzophenone-5-sulfonic acid and its salts, 2,2′-dihydroxy-4,4′-dimethoxybenzophenone-5,5′-sulfonic acid and its salts;
G) 3-benzylidenecamphor and derivatives thereof, such as 3-(4′-methylbenzylidene)d-1-camphor, benzylidenecamphorsulfonic acid;
H) sulfonic acid derivatives of 3-benzylidenecamphor, such as 4-(2-oxo-3-bornylidenemethyl)benzenesulfonic acid and 2-methyl-5-(2-oxo-3- bornylidene)sulfonic acid and salts thereof;
I) esters of benzalmalonic acid, such as 2-ethylhexyl 4-methoxybenzalmalonate;
J) triazine derivatives, such as dioctylbutamidotriazone, 2,4,6-trianilino-p-(carbo-2′-ethyl-hexyl-1′-oxy)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, anisotriazine, 2,4,6-tris(diisobutyl 4′-aminobenzalmalonate)-s-triazine;
K) propane-1,3-diones, such as 1-(4-tert-butylphenyl)-3-(4′-methoxyphenyl)propane-1,3-dione;
L) 2-phenylbenzimidazole-5-sulfonic acid or 2-phenylbenzimidazole-4-sulfonic acid and alkali metal, alkaline earth metal, ammonium, alkylammonium, alkanolammonium and glucammonium salts thereof;
M) derivatives of benzoylmethane, such as 1-(4′-tert-butylphenyl)-3-(4′-methoxyphenyl)-propane-1,3-dione, 4-tert-butyl-4′- methoxydibenzoylmethane or 1-phenyl-3-(4′-isopropylphenyl)-propane-1,3-dione;
N) amino-hydroxy-substituted derivatives of benzophenones, such as N,N-diethylamino-hydroxybenzoyl-n-hexyl-benzoate;
O) derivatives of stilbene, for example salts of distyrylbiphenyldisulfonate, such as disodium distyrylbiphenyldisulfonate, 2,2′-[1,2-ethenediylbis[(3-sulfo-4,1-phenylene)imono-[6-(diethylamino)-1,3,5-triazine-4,2-diyl]imino]]-bis-1,4-benzenedisulfonic acid hexasodium salt;
P) Metal oxides or dioxides such as ZnO, TiO₂ or CeO₂, and the UV absorbers as described in WO 2009/153231, page 2, line 24 to page 6, line 18.
Q) Epoxidized vegetable oils, for example such as those based on but not limited to soybean, rape, palm;
R) Compounds such as camphor benzalkonium methosulfate, camphor derivatives, bis-ethylhexyloxyphenol methoxyphenyl triazine, methylene bis-benzotriazolyl tetramethylbutylphenol, Avobenzone (butyl methoxydibenzoylmethane), oxybenzone, Dioxybenzone, Ecamsule (terephthalylidene dicamphor sulfonic acid; Mexoryl® SX), Ensulizole (phenylbenzimidazole sulfonic acid), Bemotrizinol, Bisoctrizole.

As per a specific embodiment, the said photoprotective agent is titanium dioxide.

In an yet another embodiment, the said photoprotective agent is epoxidized vegetable oil.

In another embodiment, the said photoprotective agent is a combination of two or more components selected from the class photoprotective agents described above.

In a specific embodiment, the said combination of photoprotective agents is a combination of titanium dioxide and epoxidized vegetable oil.

According to an embodiment, the composition of the present invention comprises a triazolone herbicide as the herbicidal active ingredient and titanium dioxide as the photoprotective agent.

According to an embodiment, the composition of the present invention comprises a triazolone herbicide as the herbicidal active ingredient and epoxidized vegetable oil as the photoprotective agent.

According to an embodiment, the composition of the present invention comprises a triazolone herbicide as the herbicidal active ingredient and a combination of titanium dioxide and epoxidized vegetable oil as the photoprotective agent.

According to a specific embodiment, the composition of the present invention comprises amicarbazone as the herbicidal active ingredient and titanium dioxide as the photoprotective agent.

According to a specific embodiment, the composition of the present invention comprises amicarbazone as the herbicidal active ingredient and epoxidized vegetable oil as the photoprotective agent.

According to a specific embodiment, the combination of the present invention comprises amicarbazone as the herbicidal active ingredient and a combination of titanium dioxide and epoxidized vegetable oil as the photoprotective agent.

According to a specific embodiment, the composition of the present invention comprises sulfentrazone as the herbicidal active ingredient and titanium dioxide as the photoprotective agent.

According to a specific embodiment, the composition of the present invention comprises sulfentrazone as the herbicidal active ingredient and epoxidized vegetable oil as the photoprotective agent.

According to a specific embodiment, the combination of the present invention comprises sulfentrazone as the herbicidal active ingredient and a combination of titanium dioxide and epoxidized vegetable oil as the photoprotective agent.

According to an embodiment, the amount of triazolone herbicide in the composition of the present invention ranges from 20 g/L to 1000 g/L by weight of the composition.

According to an embodiment, the amount of triazolone herbicide in the composition is preferably 50 g/L to 500 g/L by weight of the composition, more preferably 100 g/L to 400 g/L by weight of the composition.

According to an embodiment, the amount of amicarbazone in the composition of the present invention ranges from 20 g/L to 1000 g/L by weight of the composition.

According to an embodiment, the amount of amicarbazone in the composition is preferably 50 g/L to 500 g/L by weight of the composition, more preferably 100 g/L to 400 g/L by weight of the composition.

According to an embodiment, the amount of sulfentrazone in the composition of the present invention ranges from 20 g/L to 1000 g/L by weight of the composition.

According to an embodiment, the amount of sulfentrazone in the composition is preferably 50 g/L to 800 g/L by weight of the composition, more preferably 100 g/L to 700 g/L by weight of the composition.

According to an embodiment, the amount of sulfentrazone in the composition is preferably 200 g/L to 600 g/L by weight of the composition.

According to an embodiment, the amount of the said photoprotective agent or a combination thereof ranges from 0.1 to 70%, preferably 1 to 60%.

According to an embodiment, the amount of titanium dioxide in the composition ranges from 0.1 to 70%, preferably 1 to 60%.

According to an embodiment, the amount of epoxidized vegetable oil in the composition ranges from 0.1 to 50%, preferably 1 to 60%

The total amount of photoprotective agent in the agrochemical formulation is in general 0.1 to 70 wt %, preferably 1 to 5 wt %, and more preferably 1 to 2 wt %. The weight ratio of the organic UV photoprotective filter to the triazolone herbicide is usually in a range of 1:500 to 1:1, preferably 1:100 to 1:10, more preferably 1:50 to 1:20.

An aspect of the present invention is to provide a method of protecting a triazolone herbicide from photodamage, wherein the method comprises adding a photoprotective agent to the composition comprising the said herbicide.

According to an embodiment, the said triazolone herbicide is selected from amicarbazone, bencarbazone, carfentrazone, carfentrazone-ethyl, flucarbazone, ipfencarbazone, propoxycarbazone, sulfentrazone and thiencarbazone.

According to an embodiment, the said triazolone herbicide is amicarbazone.

According to an embodiment, the said triazolone herbicide is sulfentrazone.

According to an embodiment, the said triazolone herbicide is flucarbazone.

According to an embodiment, the said triazolone herbicide is carfentrazone or carfentrazone-ethyl.

According to an embodiment, the said triazolone herbicide is ipfencarbazone.

According to an embodiment, the said triazolone herbicide is propoxycarbazone.

According to an embodiment, the said triazolone herbicide is thiencarbazone.

As per another embodiment, the said photoprotective agent is selected from
A) benzotriazoles, such as 2-(2H-benzotriazol-2-yl)-4,6-bis(1-methyl-1-phenylethyl)phenol, [3-[3-(2H-benzotriazol-2-yl)-5-(1,1-dimethylethyl)-4-hydroxyphenyl]-1-oxopropyl]-w-[3-[3-(2H-benzotriazol-2-yl)-5-(1,1-dimethylethyl)-4-hydroxyphenyl]-1-oxopropoxyl]poly(oxy-1,2-ethanediyl), 6-tert-butyl-2-(5-chloro-2H-benzotriazol-2-yl)-4-methylphenol, 2,4-di-tert-butyl-6-(5-chloro-2H-benzotriazol-2-yl)-phenol, 2-(2H-benzotriazol-2-yl)-4,6-di-tert-pentylphenol, 2-(2H-benzotriazol-2-yl)-4-(1,1,3,3-tetramethylbutyl)-phenol, 2-(2H-benzotriazol-2-yl)-4-methylphenol, 2-(2H-benzotriazol-2-yl)-4,6-bis(1-methyl-1-phenylethyl)phenol, 2,2-methylenebis(6-(benzotriazol-2-yl)-4-tert-octylphenol; 2-(2H-benzotriazol-2-yl)-2-(2-methylpropyl)phenol-4-sulfonic acid sodium salt, phenol, 2-(2H-benzotriazol-2-yl)-6-dodecyl-4-methyl-, branched and linear;
B) cyanoacrylates, such as 2-cyano-3-phenylcinnamate ethyl ester, 2-cyano-3,3-diphenylacrylic acid 2′-ethylhexyl ester or 2-ethylhexyl 2-cyano-3-phenylcinnamate;
C) para-aminobenzoic acid (PABA) derivatives, in particular esters, such as ethyl PABA, ethoxylated PABA, ethyl dihydroxypropyl-PABA, glycerol-PABA, 2-ethylhexyl 4-(dimethylamino)benzoate, 2-octyl 4-(dimethylamino)benzoate, amyl 4- (dimethylamino)benzoate, 4-bis(polyethoxy)-4-aminobenzoic acid polyethoxyethyl ester;
D) esters of salicylic acid, such as 2-ethylhexyl salicylate, 4-isopropylbenzyl salicylate, homomethyl salicylate (homosalate), TEA salicylate, dipropylene glycol salicylate, Ethylhexyl salicylate (octyl salicylate/octisalate), Trolamine salicylate;
E) esters of cinnamic acids, such as 2-ethylhexyl 4-methoxycinnamate, octyl p-methoxycinnamate (octinoxate), propyl 4-methoxycinnamate, isoamyl 4-methoxycinnamate, cinoxate, diisopropyl methylcinnamate, ethoxyethyl p-methoxycinnamate (cinoxate), etocrylene, octocrylene;
F) derivatives of benzophenone, such as 2-hydroxy-4-methoxybenzophenone, 2-hydroxy-4-methoxy-4′-methylbenzophenone, 2,2′-dihydroxy-4-methoxybenzophenone, 2-(4-diethylamino-2-hydroxybenzoyl)-benzoic acid hexyl ester, 4-n-octyloxy-2-hydroxy-benzophenone 2-hydroxybenzophenone derivatives, such as 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone, sulfonic acid derivatives of benzophenones, such as 2-hydroxy-4-methoxybenzophenone-5-sulfonic acid and its salts, 2,2′-dihydroxy-4,4′-dimethoxybenzophenone-5,5′-sulfonic acid and its salts;
G) 3-benzylidenecamphor and derivatives thereof, such as 3-(4′-methylbenzylidene)d-1-camphor, benzylidenecamphorsulfonic acid;
H) sulfonic acid derivatives of 3-benzylidenecamphor, such as 4-(2-oxo-3-bornylidenemethyl)benzenesulfonic acid and 2-methyl-5-(2-oxo-3-bornylidene)sulfonic acid and salts thereof;
I) esters of benzalmalonic acid, such as 2-ethylhexyl 4-methoxybenzalmalonate;
J) triazine derivatives, such as dioctylbutamidotriazone, 2,4,6-trianilino-p-(carbo-2′-ethyl-hexyl-1′-oxy)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, anisotriazine, 2,4,6-tris(diisobutyl 4′-aminobenzalmalonate)-s-triazine;
K) propane-1,3-diones, such as 1-(4-tert-butylphenyl)-3-(4′-methoxyphenyl)propane-1,3-dione;
L) 2-phenylbenzimidazole-5-sulfonic acid or 2-phenylbenzimidazole-4-sulfonic acid and alkali metal, alkaline earth metal, ammonium, alkylammonium, alkanolammonium and glucammonium salts thereof;
M) derivatives of benzoylmethane, such as 1-(4′-tert-butylphenyl)-3-(4′-methoxyphenyl)-propane-1,3-dione, 4-tert-butyl-4′- methoxydibenzoylmethane or 1-phenyl-3-(4′-isopropylphenyl)-propane-1,3-dione;
N) amino-hydroxy-substituted derivatives of benzophenones, such as N,N-diethylamino-hydroxybenzoyl-n-hexyl-benzoate;
O) derivatives of stilbene, for example salts of distyrylbiphenyldisulfonate, such as disodium distyrylbiphenyldisulfonate, 2,2′-[1,2-ethenediylbis[(3-sulfo-4,1-phenylene)imono-[6-(diethylamino)-1,3,5-triazine-4,2-diyl]imino]]-bis-1,4-benzenedisulfonic acid hexasodium salt;
P) Metal oxides or dioxides such as ZnO, TiO₂ or CeO₂, and the UV absorbers as described in WO 2009/153231, page 2, line 24 to page 6, line 18;
Q) Epoxidized vegetable oils, for example such as those based on but not limited to soybean oil, rapeseed/canola oil, olive oil, castor oil, sunflower seed oil, coconut oil, corn oil, cottonseed oil, linseed oil, palm oil, peanut oil, safflower oil, sesame oil, tung oil, etc.;
R) Compounds such as camphor benzalkonium methosulfate, camphor derivatives, bis-ethylhexyloxyphenol methoxyphenyl triazine, methylene bis-benzotriazolyl tetramethylbutylphenol, Avobenzone (butyl methoxydibenzoylmethane), oxybenzone, Dioxybenzone, Ecamsule (terephthalylidene dicamphor sulfonic acid; Mexoryl® SX), Ensulizole (phenylbenzimidazole sulfonic acid), Bemotrizinol, Bisoctrizole.

As per a specific embodiment, the said photoprotective agent is titanium dioxide.

In an yet another embodiment, the said photoprotective agent is epoxidized vegetable oil.

In another embodiment, the said photoprotective agent is a combination of two or more components selected from the class photoprotective agents described above.

In a specific embodiment, the said combination of photoprotective agents is a combination of titanium dioxide and epoxidized vegetable oil.

An aspect of the present invention provides a method of preparing a stable composition comprising adding at least one photoprotective agent to a triazolone herbicide.

Another aspect of the present invention provides a composition comprising at least one triazolone herbicide, at least one photoprotective agent and at least one agrochemically suitable excipient.

The agrochemically suitable excipient carrier may be any one or a combination of adjuvants, co-solvents, surfactants, colorants, emulsifiers, thickeners, antifreeze agents, biocides, anti-foam agents, stabilizers, wetting agents or a mixture thereof which may be optionally added to the compositions of the present invention.

The surfactants may be selected from non-ionic, anionic or cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C12-C15 alkanols or polyalkoxylated C12-C15 alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C8-C18 fatty acids and C8-C18 fatty amine polyalkoxylates, C8-C18 alkyldimethylbenzylammonium chlorides, coconut alkyldimethylaminoacetic acids, and phosphate esters of C8-C18 fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminum silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, and polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, and octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, and inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Olive Oil, Mono and Di Glycerides, Paraffin Oil, Paraffin Wax, Poly Propylene Glycol, Silicone Oils, Vegetable and Animal Fats, Vegetable and Animal Fat Sulfates, Vegetable & Animal Oil, Vegetable and Animal Oil Sulfates, Vegetable and Animal Waxes, Vegetable and Animal Wax Sulfate, and agents based on silicon or magnesium stearate.

Representative organic liquids which can be employed in preparing the emulsifiable concentrates of the present invention are the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of the emulsifiable concentrate. The formulations can also contain other compatible additives, for example, plant growth regulators and other biologically active compounds used in agriculture.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

The agrochemical formulation may also comprise one or more antioxidants. Preferably, the agrochemical formulation comprises an antioxidants. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g. α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA, EGTA, phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g. stilbene oxide, trans-stilbene oxide). According to the invention, suitable derivatives (salts, esters, sugars, nucleotides, nucleosides, peptides and lipids) and mixtures of these specified active ingredients or plant extracts (e.g., tea tree oil, rosemary extract and rosemarinic acid) which comprise these antioxidants can be used. In general, mixtures of the aforementioned antioxidants are possible.

According to an embodiment, examples of suitable solvents are water, aromatic solvents (for example Solvesso products, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of suitable carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.).

Suitable preservatives are for example 1,2-benzisothiazolin-3-one and/or 2-Methyl-2H-isothiazol-3-one or sodium benzoate or benzoic acid.

According to an embodiment, concentrated formulations can be dispersed in water, or another liquid, for application, or formulations can be dust-like or granular. The formulations are prepared according to procedures which are conventional in the agricultural chemical art, but which are novel and important because of the presence therein of a composition. The formulations that are applied most often are aqueous suspensions or emulsions. Either such water-soluble, water-suspendable, or emulsifiable formulations are solids, usually known as wettable powders, or liquids, usually known as emulsifiable concentrates, aqueous suspensions, or suspension concentrates. The present disclosure contemplates all vehicles by which the compositions can be formulated for delivery and use as an herbicide.

The compositions of the present invention may also be formulated as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ULV) liquid, ultra low volume (ULV) suspension, water dispersible granules or tablets, water dispersible powder for slurry treatment, water soluble granules or tablets, water soluble powder for seed treatment and wettable powder. More specifically, the compositions are formulated as solutions, emulsions, suspensions, dusts, powders, pastes, granules, pressings, capsules, and mixtures thereof. Examples for composition types are suspensions (e.g., SC, OD, FS), emulsifiable concentrates (e.g., EC), emulsions (e.g., EW, EO, ES, ME), capsules (e.g., CS, ZC), pastes, pastilles, wettable powders or dusts (e.g., WP, SP, WS, DP, DS), pressings (e.g., BR, TB, DT), granules (e.g., WG, SG, GR, FG, GG, MG), insecticidal articles (e.g., LN), as well as gel formulations for the treatment of plant propagation materials such as seeds (e.g., GF).

An embodiment of the present invention provides a method of making a composition comprising at least one triazolone herbicide, at least one photoprotective agent and at least one agrochemically suitable excipient.

Another aspect of the present invention provides a method of controlling weeds by applying a composition comprising at least one triazolone herbicide and at least one photoprotective agent.

Another aspect of the present invention provides a method of benefitting the crops and/or their growth, health, yield or vigor by applying a composition comprising at least one triazolone herbicide and at least one photoprotective agent.

The herbicidal combination of the present invention may be used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, sugarcane etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The target weeds may be selected from Alopecurus myosuroides Huds. (blackgrass, ALOMY), Alternanthera tenella (ALRTE), Amaranthus hybridus (AMAHH) Amaranthus palmeri (Palmer amaranth, AMAPA), Amaranthus retroflexus (redroot pigweed AMARE), Amaranthus viridis (slender amaranth, AMAVI), Avena fatua (wild oat, AVEFA), Avena sativa (common oat, AVESA), Bidens subalternans (greater beggarticks, BIDSU), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Chloris polydactyla (CHRPO), Digitaria horizontalis Willd. (Jamaican crabgrass, DIGHO), Digitaria insularis (sourgrass, TRCIN), Digitaria nuda (DIGNU), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoca lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE) or Xanthium strumarium (common cocklebur, XANST), Ricinus communis (castorbean, RIICO).

In another embodiment, the weed is selected from crabgrass complex (Digitaria horizontalis, Digitaria nuda and others), guinea grass (Panicum maximum), Surinam grass (Brachiaria decumbens), morning glories (Ipomoca grandifolia, Ipomoca nil, Ipomoca quamoclit, Ipomoca purpurea, Ipomoea hederifolia, Merremia cissoides and Merremia aegypta), beggar-ticks (Bidens pilosa), Java grass or purple nut sedge (Cyperus rotundus and Cyperus spp), Indian goosegrass or crowfoot grass (Eleusine indica), southern sandbur (Cenchrus echinatus), velvet bean or mucuna (Mucuna pruriens), wild poinsettia or milkweed (Euphorbia heterophylla), Paraguayan starbur (Acanthospermum australe), Slender amaranth (Amaranthus viridis), Alexandergrass (Brachiaria plantaginea), Benghal dayflower (Commelina benghalensis), Lilac tasselflower (Emilia sonchifolia), Wild poinsettia or milkweed (Euphorbia heterophylla), Gallant soldier (Galinsoga parviflora), Purslane or pigweed (Portulaca oleracea), Brazilian calla-lily or Brazil pusley (Richardia brasiliensis), Flannel weed (Sida cordifolia), Southern sida (Sida glaziovii), Southern sida (Sida rhombifolia), Buttonweed or broad-leaved buttonweed (Spermacoce latifólia).

In one preferred embodiment, the weed is selected from the group consisting of Amaranthus, Cyperus and, Brachiaria decumbens, Cenchrus echinatus, Eleusine indica, Digitaria insularis, Ipomoea grandifolia, Euphorbia heterophylla, Commelina benghalensis, Amaranthus viridis, Amaranthus spinosus, Merremia, Ricinus communis Mucuna, Acalypha indica, Commelina communis, Digera arvensis, Euphorbia geniculate, Portulaca oleracea, Parthenium hysterophrous, Phyllanthus maderaspatnesis, Bracchiria spp, Dactyloctenium ageptisian and Echinochloa colonum.

According to an embodiment the herbicidal composition of the present invention may be applied at any time either before or after the emergence of the weeds. Further, the herbicidal composition of the present invention may take various application forms such as soil application, foliar application, irrigation application, and submerged application, and it can be applied to agricultural fields such as upland fields, orchards and paddy fields, and non-cropland such as ridges of fields, fallow fields, playgrounds, golf courses, vacant lands, forests, factory sites, railway sides and roadsides. Further the application may happen on locus of plant such as leaves, stems, patterns, flowers, buds, fruits, seeds, sprout, roots, tubers, tuberous roots, shoots, cuttings, generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

In an embodiment, the composition of the present invention is applied as a pre-emergence herbicide.

In an embodiment, the composition of the present invention is applied as a post-emergence herbicide.

An embodiment provides use of a stable composition comprising a triazolone herbicide and at least one photoprotective agent in reduction or eradication of weeds in crops, preferably sugarcane, soybean, corn, coffee and eucalyptus.

An embodiment provides a method of reducing or eradicating weeds in crops, preferably sugarcane, soybean, corn, coffee and eucalyptus by application of a stable composition comprising a triazolone herbicide and at least one photoprotective agent.

Without departing from the scope of the subject matter, the mixture and formulations of the present subject matter may be applied in conjunction with one or more co-herbicides to control a wider variety of undesirable vegetation. When used in conjunction with co-herbicides, the composition can be formulated with the co-herbicide or co-herbicides, tank mixed with the co-herbicide or co-herbicides or applied sequentially with the co-herbicide or co-herbicides.

Another aspect of the present invention also provides a composition comprising a triazolone herbicide, at least one photoprotective agent and a second herbicide.

According to an embodiment, the second herbicide is selected from but are not limited to 2,4-D, 2,4-D-butotyl, 2,4-D-butyl, 2,4-D-dimethylammonium, 2,4-D-diolamine, 2,4-D-ethyl, 2,4-D-2-ethylhexyl, 2,4-D-isobutyl, 2,4-D-isoctyl, 2,4-D-isopropyl, 2,4-D-isopropylammonium, 2,4-D-sodium, 2,4-D-isopropanolammonium, 2,4-D-trolamine, 2,4-DB, 2,4-DB-butyl, 2,4-DB-dimethylammonium, 2,4-DB-isoctyl, 2,4-DB-potassium, 2,4-DB-sodium, dichlorprop, dichlorprop-butotyl, dichlorprop-dimethylammonium, dichlorprop-isoctyl, dichlorprop-potassium, dichlorprop-P, dichlorprop-P-dimethylammonium, dichlorprop-P-potassium, dichlorprop-P-sodium, MCPA, MCPA-butotyl, MCPA-dimethylammonium, MCPA-2-ethylhexyl, MCPA-potassium, MCPA-sodium, MCPA-thioethyl, MCPB, MCPB-ethyl, MCPB-sodium, mecoprop, mecoprop-butotyl, mecoprop-sodium, mecoprop-P, mecoprop-P-butotyl, mecoprop-P-dimethylammonium, mecoprop-P-2-ethylhexyl, mecoprop-P-potassium, naproanilide, clomeprop, 2,3,6-TBA, dicamba, dicamba-butotyl, dicamba-diglycolamine, dicamba-dimethylammonium, dicamba-diolamine, dicamba-isopropylammonium, dicamba-potassium, dicamba-sodium, dichlobenil, picloram, picloram-dimethylammonium, picloram-isoctyl, picloram-potassium, picloram-triisopropanolammonium, picloram-triisopropylammonium, picloram-trolamine, triclopyr, triclopyr-butotyl, triclopyr-triethylammonium, clopyralid, clopyralid-olamine, clopyralid-potassium, clopyralid-triisopropanolammonium, aminopyralid, naptalam, naptalam-sodium, benazolin, benazolin-ethyl, quinclorac, quinmerac, diflufenzopyr, diflufenzopyr-sodium, fluroxypyr, fluroxypyr-2-butoxy-1-methylethyl, fluroxypyr-meptyl, chlorflurenol, chlorflurenol-methyl, aminocyclopyrachlor, aminocyclopyrachlor-methyl, aminocyclopyrachlor-potassium, chlorotoluron, diuron, fluometuron, linuron, isoproturon, metobenzuron, tebuthiuron, dimefuron, isouron, karbutilate, methabenzthiazuron, metoxuron, monolinuron, neburon, siduron, terbumeton, trietazine, metobromuron, simazine, atrazine, atratone, simetryn, prometryn, dimethametryn, hexazinone, metribuzin, teroutnyiazine, cyanazine, ametryn, cybutryne, triaziflam, indaziflam, terbutryn, propazine, metamitron, prometon, bromacil, bromacyl-lithium, lenacil, terbacil, propanil, cypromid, swep, desmedipham, phenmedipham, bromoxynil, bromoxynil-octanoate, bromoxynil-heptanoate, ioxynil, ioxynil-octanoate, ioxynil-potassium, ioxynil-sodium, pyridate, bentazone, bentazone-sodium, amicarbazone, methazole, pentanochlor, paraquat, diquat, nitrofen, chlomethoxyfen, bifenox, acifluorfen, acifluorfen-sodium, fomesafen, fomesafen-sodium, oxyfluorfen, lactofen, aclonifen, ethoxyfen-ethyl (HC-252), fluoroglycofen-ethyl, fluoroglycofen, chlorphthalim, flumioxazin, flumiclorac, flumiclorac-pentyl, cinidon-ethyl, fluthiacet, fluthiacet-methyl, oxadiargyl, oxadiazon, sulfentrazone, carfentrazone-ethyl, thidiazimin, pentoxazone, azafenidin, isopropazole, pyraflufen-ethyl, benzfendizone, butafenacil, saflufenacil, flupoxam, fluazolate, profluazol, pyraclonil, flufenpyr-ethyl, bencarbazone, ethyl[3-(2-chloro-4-fluoro-5-(3-methyl-2,6-dioxo-4-trifluoromethyl-3,6-dihydro-2H-pyrimidin-1-yl)phenoxy)pyridin-2-yloxy]acetate (SYN-523), norflurazon, chloridazon, metflurazon, pyrazolynate, pyrazoxyfen, benzofenap, topramezone, pyrasulfotole, amitrole, fluridone, flurtamone, diflufenican, methoxyphenone, clomazone, sulcotrione, mesotrione, tembotrione, tefuryltrione, bicyclopyrone, isoxaflutole, difenzoquat, difenzoquat-metilsulfate, isoxachlortole, benzobicyclon, picolinafen, beflubutamid, diclotop-methyl, diclotop, pyriphenop-sodium, fluazifop-butyl, fluazifop, fluazifop-P, fluazifop-P-butyl, haloxyfop-methyl, haloxyfop, haloxyfop-etotyl, haloxyfop-P, haloxyfop-P-methyl, quizalofop-ethyl, quizalofop-P, quizalofop-P-ethyl, quizalofop-P-tefuryl, cyhalofop-butyl, fenoxaprop-ethyl, fenoxaprop-P, fenoxaprop-P-ethyl, metamifop-propyl, metamifop, clodinafop-propargyl, clodinafop, propaquizafop, alloxydim-sodium, alloxydim, clethodim, sethoxydim, tralkoxydim, butroxydim, tepraloxydim, profoxydim, cycloxydim, flamprop-M-methyl, flamprop-M, flamprop-M-isopropyl, chlorimuron-ethyl, chlorimuron, sulfometuron-methyl, sulfometuron, primisulfuron-methyl, primisulfuron, bensulfuron-methyl, bensulfuron, chlorsulfuron, metsulfuron-methyl, metsulfuron, cinosulfuron, pyrazosulfuron-ethyl, pyrazosulfuron, azimsulfuron, rimsulfuron, imazosulfuron, cyclosulfamuron, prosulfuron, flupyrsulfuron-methyl-sodium, flupyrsulfuron, triflusulfuron-methyl, triflusulfuron, halosulfuron-methyl, halosulfuron, thifensulfuron-methyl, thifensulfuron, ethoxysulfuron, oxasulfuron, ethametsulfuron, ethametsulfuron-methyl, iodosulfuron, iodosulfuron-methyl-sodium, sulfosulfuron, triasulfuron, tribenuron-methyl, tribenuron, tritosulfuron, foramsulfuron, trifloxysulfuron, trifloxysulfuron-sodium, mesosulfuron, mesosulfuron-methyl, orthosulfamuron, flucetosulfuron, amidosulfuron, propyrisulfuron, metazosulfuron, iofensulfuron, flumetsulam, metosulam, diclosulam, cloransulam-methyl, florasulam, penoxsulam, pyroxsulam, imazapyr, imazapyr-isopropylammonium, imazethapyr, imazethapyr-ammonium, imazaquin, imazaquin-ammonium, imazamox, imazamox-ammonium, imazamethabenz, imazamethabenz-methyl, imazapic, pyrithiobac-sodium, bispyribac-sodium, pyriminobac-methyl, pyribenzoxim, pyriftalid, pyrimisulfan, triafamone, flucarbazone, ilucarbazone-sodium, propoxycarbazone-sodium, propoxycarbazone or thiencarbazone, glyphosate, glypho sate-sodium, glyphosate-potassium, glypho sate-ammonium, glyphosate-diammonium, glyphosate-isopropylammonium, glyphosate-trimesium, glyphosate-sesquisodium, glufosinate, glufosinate-ammonium, glufosinate-P, glufosinate-P-ammonium, glufosinate-P-sodium, bilanafos, bilanafos-sodium, cinmethylin, trifluralin, oryzalin, nitralin, pendimethalin, ethalfluralin, benfluralin, prodiamine, butralin, dinitramine, bensulide, napropamide, propyzamide, pronamide, amiprofos-methyl, butamifos, anilofos, piperophos, propham, chlorpropham, barban, carbetamide, daimuron, cumyluron, bromobutide, methyldymron, asulam, asulam-sodium, dithiopyr, thiazopyr, chlorthal-dimethyl, chlorthal, diphenamid, alachlor, metazachlor, butachlor, pretilachlor, metolachlor, thenylchlor, pethoxamid, acetochlor, propachlor, dimethenamid, dimethenamid-P, propisochlor, dimethachlor, molinate, dimepiperate, pyributicarb, EPTC, butylate, vernolate, pebulate, cycloate, prosulfocarb, esprocarb, thiobencarb, triallate, diallate, orbencarb, etobenzanid, flufenacet, mefenacet, tridiphane, cafenstrole, fentrazamide, oxaziclomefone, indanofan, benfuresate, pyroxasulfone, fenoxasulfone, dalapon, dalapon-sodium, TCA-sodium, trichloroacetic acid, MSMA, DSMA, CMA, endothall, endothall-dipotassium, endothall-sodium, endothall-mono(N,N-dimethylalkylammonium), ethofumesate, sodium chlorate, pelargonic acid (nonanoic acid), fosamine, fosamine-ammonium, pinoxaden, ipfencarbazone, aclolein, ammonium sulfamate, borax, chloroacetic acid, sodium chloroacete, cyanamide, methylarsonic acid, dimethylarsinic acid, sodium dimethylarsinate, dinoterb, dinoterb-ammonium, dinoterb-diolamine, dinoterb-acetate, DNOC, ferrous sulfate, flupropanate, flupropanate-sodium, isoxaben, mefluidide, mefluidide-diolamine, metam, metam-ammonium, metam-potassium, metam-sodium, methyl isothiocyanate, pentachlorophenol and sodium pentachlorophenoxide.

According to a specific embodiment, the second herbicide is sulfentrazone.

According to an embodiment, the composition of the present invention comprises amicarbazone, at least one photoprotective agent and a second herbicide.

According to an embodiment, the composition of the present invention comprises amicarbazone, at least one photoprotective agent and sulfentrazone.

According to an embodiment, the composition of the present invention comprises amicarbazone, titanium dioxide and sulfentrazone.

According to an embodiment, the composition of the present invention comprises amicarbazone, epoxidized vegetable oil and sulfentrazone.

According to an embodiment, the composition of the present invention comprises amicarbazone, a combination of titanium dioxide and epoxidized vegetable oil; and sulfentrazone.

As per an embodiment, the said second herbicide is added to the composition in quantities 50 g/L to 1500 g/L by weight of the composition.

According to a specific embodiment, the amount of second herbicide in composition is 100 g/L to 1000 g/L.

According to yet another embodiment, the amount of second herbicide in composition is 200 g/L to 700 g/L.

According to yet another embodiment, the amount of second herbicide in composition is 200 g/L to 600 g/L.

Another aspect of the present invention also provides a composition comprising a first triazolionone herbicide, a second triazolone herbicide and at least one photoprotective agent; wherein the second triazolone herbicide is not the first triazolone herbicide.

An embodiment provides a composition comprising amicarbazone, a second triazolone herbicide and at least one photoprotective agent; wherein the second triazolone herbicide is not amicarbazone.

An embodiment provides a composition comprising sulfentrazone, a second triazolone herbicide and at least one photoprotective agent; wherein the second triazolone herbicide is not sulfentrazone.

As per an embodiment, the components of the composition of the present disclosure can be applied either separately or as part of a multipart herbicidal system. The components may be applied as ready mix or a tank-mix. The components may be applied sequentially in any order or together as a premix or a tank mix. The components demonstrate synergy when applied in any method.

The compositions of the present invention may be conveniently prepared in concentrated form or in a ready-to-use form.

The present compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In an embodiment, the application rates of the mixtures of the present invention range from 0.05 L/ha to 10.0 L/ha, preferably from 0.1 L/ha to 5.0 L/ha.

In an embodiment, the dosage of triazolone herbicide ranges from 10 to 2000 g a.i/Ha, more specifically 50 to 1500 g a.i/Ha.

In an embodiment, the dosage of photoprotectant ranges from 1 to 2000 g a.i/Ha, more specifically 10 to 1000 g a.i/Ha.

In an embodiment, the dosage of optional second herbicide ranges from 10 to 2000 g a.i/Ha, more specifically 50 to 1500 g a.i/Ha.

An aspect of the present invention also provides a kit of parts comprising as separate components:
a) A triazolone herbicide;
b) at least one photoprotective agent;
c) optionally, a second herbicide;
d) optionally, at least one agrochemically acceptable excipient.

An embodiment of the present invention provides a kit of parts comprising the herbicidal mixture as described herein, or components thereof. Such kits may comprise, in addition to the aforementioned active components, one or more additional active and/or inactive ingredients, either within the provided herbicidal composition or separately.

In an embodiment, the kit-of-parts comprises an instructions manual, said instructions manual comprising instructions directing a user to admix the components before being used.

In those embodiments where more than two components are provided in a kit, the components may already be combined together and as such are packaged in a single container such as a vial, bottle, can, pouch, bag or canister. In other embodiments, two or more components of a kit may be packaged separately, i. e., not pre-formulated. As such, kits may include one or more separate containers such as vials, cans, bottles, pouches, bags or canisters, each container containing a separate component for an agrochemical composition. In both forms, a component of the kit may be applied separately from or together with the further components or as a component of a combination composition according to the invention for preparing the composition according to the invention.

The invention is further illustrated but not limited by the following examples.

### EXAMPLE 1

Three solutions of SC formulation comprising 300g/L sulfentrazone and 200g/L amicarbazone were prepared by simulating an application volume of 150 L/ha. One sample contained titanium dioxide in the formulation simulating a dosage of 4000 g or ml/ha. Another sample contained epoxidized vegetable oil in the formulation simulating a dosage of 4000 g or ml/ha. The third sample prepared was a tank mix comprising amicarbazone and sulfentrazone (500 g/L+700 g/L).

The concentrations of amicarbazone detected by the Liquid Chromatograph were analyzed by applying the F test on the analysis of variance, in order to detect the significance of the interaction. When significant, the period of evaluation factor (AAD) levels were analyzed using logistic nonlinear regression. The herbicide concentration variable was adjusted to the model proposed by Streibig et al., (1988).

$$y = \frac{a}{1 + {( \frac{x}{{x}_{0}} )}^{b}}$$

where y=herbicide concentration; x=period after application; and a, x₀ and b=curve parameters, where a is the difference between the maximum and;
minimum points of the curve, x₀ is the period that provides 50% of the response of the variable and b is the curve slope.

The following table shows the formulation details and dosage parameter along with regression parameters for amicarbazone photodegradation:

| Active | | Dose | | Regression | Regression | | |
|---|---|---|---|---|---|---|---|
| (Concentration | Formulation | (g or | | parameters | parameters | | |
| g/L) | with | ml/ha) | ia/ha | a | b | X₀ | R² |
| Sulfentrazone + | Titanium | 4000 | 1200 + | 99.9808 | 0.7096 | 71.0193 | 0.9362 |
| Amicarbazone | dioxide | | 800 | | | | |
| (300 + 200) | | | | | | | |
| Sulfentrazone + | Epoxidized | 4000 | 1200 + | 100.0161 | 0.8716 | 60.0821 | 0.96 |
| Amicarbazone | vegetable | | 800 | | | | |
| (300 + 200) | oil | | | | | | |
| Amicarbazone + | — | 2400 + | 1200 + | 99.8887 | 0.5477 | 52.6898 | 0.9587 |
| Sulfentrazone | | 1143 | 800 | | | | |
| (500 + 700) | | | | | | | |

x₀ is the period that provides 50% of the response of the variable.

In this case, represents the amount of time necessary for 50% of amicarbazone photodegradation to occur.

The commercial formulation of amicarbazone would require 52.7 days to photodegrade up to 50%, while the formulations with Epoxidized Vegetable Oil and Titanium Dioxide would need 60.1 and 71.0 days, respectively,

This difference represents a protection of the amicarbazone from the formulations with Epoxidized Vegetable Oil and Titanium Dioxide respectively 14% and 35% higher than amicarbazone (with sulfentrazone in tank-mix).

### EXAMPLE 2

Two SC formulations of amicarbazone and sulfentrazone (200 and 300 g/L) were prepared as a spray solution by mixing 0.35 ml of the formulation in 1500 ml of water. 1.5 ml of this solution was filled 2 ml glass vial for analysis. Three repetitions and 16 treatments were planned for this experiment. Day zero samples were kept in refrigerator without contact with light. The sample were subjected to UV Photodegradation Chamber and evaluations were recorded at 0, 4, 8 and 16 days of exposure to the UV light.
Sample 1: SC Formulation of amicarbazone and sulfentrazone without photoprotector
Sample 2: SC Formulation of amicarbazone and sulfentrazone with combination of titanium dioxide and epoxidized vegetable oil

The concentrations of amicarbazone detected by the Liquid Chromatograph were analyzed by applying the F test on the analysis of variance, in order to detect the significance of the interaction. When significant, the period of evaluation factor (DAA) levels were analyzed using logistic nonlinear regression. The herbicide concentration variable was adjusted to the model proposed by Streibig et al., (1988).

$$y = \frac{a}{1 + {( \frac{x}{{x}_{0}} )}^{b}}$$

where y=herbicide concentration; x=period after application; and a, x₀ and b=curve parameters, where a is the difference between the maximum and minimum points of the curve, x₀ is the period that provides 50% of the response of the variable and b is the curve slope.

The following table shows regression parameters for amicarbazone photodegradation in UV chamber.

| | | Regression | Regression | | |
|---|---|---|---|---|---|
| Active | Formulation | parameters | parameters | | |
| (Concentration g/L) | with | a | b | x₀ | R² |
| Sulfentrazone + | — | 100.25 | 2.49 | 58.78 | 0.9777 |
| Amicarbazone | | | | | |
| (300 + 200) | | | | | |
| Sulfentrazone + | Titanium | 99.97 | 0.98 | 87.06 | 0.9997 |
| Amicarbazone | dioxide + | | | | |
| (300 + 200) | epoxidized | | | | |
| | vegetable | | | | |
| | oil | | | | |

The data shows that in enclosed conditions, the combination of titanium dioxide+epoxidized vegetable oil added to the SC formulation slows down the photodegradation of amicarbazone and takes the longest time, i.e., 87 days for 50% degradation of amicarbazone as compared to 58 days without any photoprotection.

### EXAMPLE 3

Two SC formulations of amicarbazone and sulfentrazone (200 & 300 g/L) were prepared as a spray solution by mixing 0.35 ml of the formulation in 1500 ml of water. 1.5 ml of this solution was filled 2 ml glass vial for analysis. Three repetitions and 16 treatments were planned this experiment. Day zero samples were kept in refrigerator without contact with light. The sample were subjected to field conditions and evaluations were recorded at 0, 15, 30 and 60 days of exposure to the sun light.
Sample 1: SC Formulation of amicarbazone and sulfentrazone without photoprotector
Sample 2: SC Formulation of amicarbazone and sulfentrazone with epoxidized vegetable oil

The concentrations of amicarbazone detected by the Liquid Chromatograph were analyzed by applying the F test on the analysis of variance, in order to detect the significance of the interaction. When significant, the period of evaluation factor (DAA) levels were analyzed using logistic nonlinear regression. The herbicide concentration variable was adjusted to the model proposed by Streibig et al., (1988).

$$y = \frac{a}{1 + {( \frac{x}{{x}_{0}} )}^{b}}$$

where y=herbicide concentration; x=period after application; and a, x₀ and b=curve parameters, where a is the difference between the maximum and minimum points of the curve, x₀ is the period that provides 50% of the response of the variable and b is the curve slope.

The table shows regression parameters for amicarbazone photodegradation in Field conditions.

| Active | | Regression | Regression | | |
|---|---|---|---|---|---|
| (Concentration | Formulation | parameters | parameters | | |
| g/L) | with | a | b | x₀ | R² |
| Sulfentrazone + | — | 99.66 | 1.33 | 139.55 | 0.9935 |
| Amicarbazone | | | | | |
| (300 + 200) | | | | | |
| Sulfentrazone + | Epoxidized | 99.80 | 1.08 | 169.52 | 0.9948 |
| Amicarbazone | vegetable | | | | |
| (300 + 200) | oil | | | | |

The data shows that in enclosed conditions, the addition of epoxidized vegetable oil added to the SC formulation slowed down the photodegradation of amicarbazone to 169 days for 50% degradation of amicarbazone as compared to 139 days without any photoprotection.

### EXAMPLE 4

Two SC formulations of amicarbazone and sulfentrazone (200 & 300 g/L) were prepared as a spray solution by mixing 0.35 ml of the formulation in 1500 ml of water. 1.5 ml of this solution was filled 2 ml glass vial for analysis. Three repetitions and 16 treatments were planned for this experiment. Day zero samples were kept in refrigerator without contact with light. The sample were subjected to field conditions and evaluations were recorded at 0, 15, 30 and 60 days of exposure to the sun light.
Sample 1: SC Formulation of amicarbazone and sulfentrazone without photoprotector.
Sample 2: SC Formulation of amicarbazone and sulfentrazone with titanium dioxide.

The concentrations of sulfentrazone detected by the Liquid Chromatograph were analyzed by applying the F test on the analysis of variance, in order to detect the significance of the interaction. When significant, the period of evaluation factor (DAA) levels were analyzed using logistic nonlinear regression. The herbicide concentration variable was adjusted to the model proposed by Streibig et al., (1988).

$$y = \frac{a}{1 + {( \frac{x}{{x}_{0}} )}^{b}}$$

where y=herbicide concentration; x=period after application; and a, x₀ and b=curve parameters, where a is the difference between the maximum and minimum points of the curve, x₀ is the period that provides 50% of the response of the variable and b is the curve slope.

The table shows regression parameters for sulfentrazone photodegradation in Field conditions.

| | | Regression | Regression | | |
|---|---|---|---|---|---|
| Active | Formulation | parameters | parameters | | |
| (Concentration g/L) | with | a | b | x₀ | R² |
| Sulfentrazone + | — | 99.99 | 1.45 | 9.57 | 0.9998 |
| Amicarbazone | | | | | |
| (300 + 200) | | | | | |
| Sulfentrazone + | Titanium | 99.96 | 1.27 | 11.79 | 0.9986 |
| Amicarbazone | dioxide | | | | |
| (300 + 200) | | | | | |

The data shows that in enclosed conditions, the addition of titanium dioxide added to the SC formulation slowed down the photodegradation of sulfentrazone to 11 days for 50% degradation of amicarbazone as compared to 9 days without any photoprotection.

### EXAMPLE 5

Three samples of amicarbazone+sulfentrazone (200+300) SC were prepared and tested for their pre-emergence efficacy on four weeds Mucuna pruriens (MUCPR); Ricinus communis (RIICO); Merremia aegyptia (IPOPE); Cyperus rotundus (CYPRO).
Sample 1: amicarbazone+sulfentrazone (200+300)+titanium dioxide
Sample 2: amicarbazone+sulfentrazone (200+300)+epoxidized vegetable oil
Sample 3: amicarbazone+sulfentrazone (700+500) without photoprotector.

The efficacy of the samples was tested at 14 DAA, 21 DAA and 28 DAA.

DAA=Days after application.

| | Formulation | Dose | |
|---|---|---|---|
| Active (conc) | with | (g or ml/ha) | ia/ha |
| Check | — | — | — |
| Sulfentrazone + | Titanium | 500 | 150 + 100 |
| Amicarbazone (300 + 200) | dioxide | | |
| Sulfentrazone + | Epoxidized | 500 | 150 + 100 |
| Amicarbazone (300 + 200) | vegetable oil | | |
| Sulfentrazone (500) + | — | 300.0 + 142.9 | 150.0 + 100.0 |
| Amicarbazone (700) | — | | |

| MUCPR % Control | | | | |
|---|---|---|---|---|
| | Dose | 14 DAA | 21 DAA | 28 DAA |
| Treatment | (L or Kg/ha) | % Control | % Control | % Control |
| Check | — | 0.00 | 0.00 | 0.00 |
| Amicarbazone + | 0.50 | 98.25 | 97.50 | 97.50 |
| Sulfentrazone + | | | | |
| titanium dioxide | | | | |
| Amicarbazone + | 0.50 | 97.25 | 98.50 | 99.50 |
| Sulfentrazone + | | | | |
| epoxidized | | | | |
| vegetable oil | | | | |
| Sulfentrazone + | 0.3 + 0.14 | 94.00 | 94.00 | 93.00 |
| Amicarbazone | | | | |

| RIICO % Control | | | | |
|---|---|---|---|---|
| | Dose | 28 DAA | | |
| Treatment | (L or Kg/ha) | % Control | | |
| Check | — | 0.00 | | |
| Amicarbazone + | 0.50 | 91.25 | | |
| Sulfentrazone + | | | | |
| titanium dioxide | | | | |
| Amicarbazone + | 0.50 | 90.00 | | |
| Sulfentrazone + | | | | |
| epoxidized | | | | |
| vegetable oil | | | | |
| Sulfentrazone + | 0.3 + 0.14 | 87.5 | | |
| Amicarbazone | | | | |
| IPOPE % Control | | 14 DAA | 21 DAA | 28 DAA |
| | Dose | | | |
| Treatment | (L or Kg/ha) | % Control | % Control | % Control |
| Check | — | 0.00 | 0.00 | 0.00 |
| Amicarbazone + | 0.50 | 97.50 | 97.75 | 98.75 |
| Sulfentrazone + | | | | |
| titanium dioxide | | | | |
| Amicarbazone + | 0.50 | 97.00 | 96.50 | 97.00 |
| Sulfentrazone + | | | | |
| epoxidized | | | | |
| vegetable oil | | | | |
| Sulfentrazone + | 0.3 + 0.14 | 95.25 | 95.50 | 95.25 |
| Amicarbazone | | | | |

| CYPRO % Control | | 14 DAA | 21 DAA | 28 DAA |
|---|---|---|---|---|
| | Dose | % | % | % |
| Treatment | (L or Kg/ha) | Control | Control | Control |
| Check | — | 0.00 | 0.00 | 0.00 |
| Amicarbazone + | 0.50 | 93.75 | 97.75 | 98.00 |
| Sulfentrazone + | | | | |
| titanium dioxide | | | | |
| Amicarbazone + | 0.50 | 94.50 | 98.00 | 97.75 |
| Sulfentrazone + | | | | |
| epoxidized | | | | |
| vegetable oil | | | | |
| Sulfentrazone + | 0.3 + 0.14 | 84.33 | 95.25 | 94.75 |
| Amicarbazone | | | | |

From the above data, it is clear that addition of either titanium dioxide or epoxidized vegetable oil to a mixture of amicarbazone and sulfentrazone increased the efficacy against the weeds as compared to the composition without photoprotector.

1. A composition comprising at least one triazolone herbicide and at least one photoprotective agent.

2. The composition according to claim 1, wherein the triazolone herbicide is a photosensitive herbicide selected from the group consisting of amicarbazone, bencarbazone, carfentrazone, carfentrazone-ethyl, flucarbazone, ipfencarbazone, propoxycarbazone, sulfentrazone and thiencarbazone and a combination thereof.

3. The composition according to claim 1, wherein the triazolone herbicide is amicarbazone, sulfentrazone or a combination thereof.

4. The composition according to claim 1, wherein the amount of triazolone herbicide ranges from 20 g/L to 1000 g/L by weight of the composition.

5. The composition according to claim 1, wherein the photoprotective agent comprises a UV-A filter, a UV-B filter or a combination thereof.

6. The composition according to claim 1, wherein the photoprotective agent comprises titanium dioxide, epoxidized vegetable oil, or a combination thereof.

7. The composition according to claim 1, wherein the amount of photoprotective agent ranges from 0.1 to 70% by the weight of the composition.

8. The composition according to claim 1, wherein the composition additionally comprises an agrochemically suitable excipient.

9. The composition according to claim 8, wherein the agrochemically suitable excipient carrier is selected from the group consisting of adjuvants, co-solvents, surfactants, colorants, emulsifiers, thickeners, antifreeze agents, biocides, anti-foam agents, stabilizers, wetting agents, and a mixtures thereof.

10. The composition according to claim 1, wherein the composition is a photostable composition.

11. A method of protecting a triazolone herbicide from photodamage, wherein the method comprises adding a photoprotective agent to the composition comprising the triazolone herbicide.

12. The method according to claim 11, wherein the triazolone herbicide is selected from the group consisting of amicarbazone, bencarbazone, carfentrazone, carfentrazone-ethyl, flucarbazone, ipfencarbazone, propoxycarbazone, sulfentrazone and thiencarbazone.

13. The method according to claim 11, wherein the photoprotective agent is selected from titanium dioxide, epoxidized vegetable oil, and a combination thereof.

14. A photostable composition comprising amicarbazone, sulfentrazone or a combination thereof, and a photoprotective agent selected from titanium dioxide, epoxidized vegetable oil, and a combination thereof.

15. The photostable composition according to claim 14, wherein the amount of amicarbazone, sulfentrazone or a combination thereof ranges from 20 g/L to 1000 g/L by weight of the composition.

16. The photostable composition according to claim 14, wherein the amount of photoprotective agent ranges from 0.1 to 70% by the weight of the composition.

17. A method of reducing or controlling a weed population comprising applying to a locus any composition defined in claim 1.

18. The method according to claim 17, wherein the weed population is in a crop selected from sugarcane, soybean, cotton, corn, coffee and eucalyptus.

19. (canceled)

20. A kit of parts comprising as separate components:
a. a triazolone herbicide selected from amicarbazone, bencarbazone, carfentrazone, carfentrazone-ethyl, flucarbazone, ipfencarbazone, propoxycarbazone, sulfentrazone, and thiencarbazone;
b. at least one photoprotective agent selected from titanium dioxide, epoxidized vegetable oil, and a combination thereof;
c. optionally, a second herbicide selected from amicarbazone, bencarbazone, carfentrazone, carfentrazone-ethyl, flucarbazone, ipfencarbazone, propoxycarbazone, sulfentrazone, and thiencarbazone; provided the second herbicide is different from the triazolone herbicide selected as component (a); and
d. optionally, at least one agrochemically acceptable excipient.
